(19) United States
(12) Patent Application Publication
(10) Pub. No.: US 2018/0122028 A1
(43) Pub. Date: May 3, 2018

(54) Computer-Implemented System And Method For Automatic Patient Querying

(71) Applicant: Palo Alto Research Center Incorporated, Palo Alto, CA (US)

(72) Inventors: Ashish Pattekar, Cupertino, CA (US); Ramkumar Abhishek, Menlo Park, CA (US); Robert T. Krivacic, San Jose, CA (US); Lester D. Nelson, Santa Clara, CA (US); David Taylor, San Francisco, CA (US)

(21) Appl. No.: 15/342,050

(22) Filed: Nov. 2, 2016

(51) Int. Cl. G06Q 50/22; G06Q 10/06; G06F 17/30

(52) U.S. Cl. CPC G06Q 50/22; G06F 17/30648; G06F 17/30312; G06Q 10/06395

(57) ABSTRACT

A computer-implemented system and method for automatic patient querying are provided. Information regarding a user is collected. An event associated with the user is identified as a trigger event based on the collected information. One or more questions regarding the event are identified and automatically sent to the user as a prompt for information based on the trigger. Feedback is received from the user in reply to the prompt.

### FIELD

This application relates in general to obtaining patient feedback, and in particular to a computer-implemented system and method for automatic patient querying.

### BACKGROUND

Patient satisfaction is becoming increasingly important due to the Affordable Care Act of 2010, which allows hospitals that are beneficiaries of Medicare Advantage plans to receive incentives based on patient satisfaction using a survey provided by the government. Hospitals with high scores will receive a bonus payment, while hospitals with low scores may face penalties. The Hospital Consumer Assessment of Healthcare Providers and Systems (HCAHPS) Survey is a standardized national survey with 32 questions for patients to provide information regarding their hospital experience, which allows comparisons to be made across hospitals using common factors. A portion of payment from the Centers for

Medicare & Medicaid Services to hospitals subject to the Inpatient Prospective Payment System annual payment is linked to hospital performance, as determined by the HCAHP survey.

Currently, hospitals, are able to determine and track their customer satisfaction scores using surveys, either in hardcopy or electronic form, which are generally provided post-discharge of a patient. For instance, hospitals often mail a hardcopy survey to a patient four to six weeks after the patient has been discharged from the hospital. However, asking a patient for feedback after that patient has already left the hospital tends to have low response rates due to the time lag of providing the survey. Further, providing surveys post-discharge does not allow the hospital time to correct any mistakes or satisfy the patient's concerns during the current visit. In contrast, receiving real time feedback may allow the hospital to rectify any concerns or dissatisfaction during the patient's stay.

Feedback can be manually obtained in real time, such as by requiring all employees of the hospital that interact with a patient to conclude with questions regarding satisfaction of the interaction. However, some patients may feel uncomfortable providing truthful feedback to the employee to whom the feedback is directed. Further, utilizing employee time to obtain the feedback reduces the efficiency of that employee to treat other patients.

Therefore, there is a need for an approach for automatically providing patient queries for feedback in real time. Preferably, the automatic patient querying will identify and provide relevant questions via a mobile computing device associated with the patient.

### SUMMARY

Determining patient satisfaction in real-time helps hospitals and other businesses to address any dissatisfaction in a timely manner to prevent bad reviews, a loss of patients or customers, and the resulting decrease in revenue. To provide real-time prompts for information from a user at relevant time, information regarding that user is collected and processed to identify an event. The identified event can act as a trigger for automatically selecting and providing one or more appropriate prompts to the user. The user can then provide feedback in reply to the prompt for determining satisfaction of the user with respect to that or a related event.

An embodiment provides a computer-implemented system and method for automatic patient querying. Information regarding a user is collected. An event associated with the user is identified as a trigger event based on the collected information. One or more questions regarding the event are identified and automatically sent to the user as a prompt for information based on the trigger. Feedback is received from the user in reply to the prompt.

Still other embodiments of the present invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a computer-implemented system for automatic patient querying, in accordance with one embodiment.

FIG. 2 is a flow diagram showing, by way of example, a process for utilizing automatic patient querying to collect patient feedback and increase patient satisfaction.

FIG. 3 is a flow diagram showing a computer-implemented method for automatic patient querying, in accordance with one embodiment.

FIG. 4 is a flow diagram showing, by way of example, a process for determining an interaction event based on location.

FIG. 5 is a flow diagram showing, by way of example, a process for determining an interaction event based on schedules.

FIG. 6 is a flow diagram showing, by way of example, a process for identifying a request for assistance.

FIG. 7 is a screenshot showing, by way of example, a webpage of compiled question and feedback data.

FIG. 8 is a screenshot showing, by way of example, a webpage of a user profile for questions and feedback data.

### DETAILED DESCRIPTION

Increasing and maintaining customer satisfaction is extremely important to businesses and other types of organizations to ensure a loyal customer base, increase revenue, and distinguish from competitors. Unfortunately, customer satisfaction is generally determined long after an event has occurred, which can prevent the business or organization from addressing current concerns or dissatisfaction of the customers with respect to the event. Allowing a business to address the customer concerns or dissatisfaction in real-time can help remedy any negative feelings of the customer to ensure that customer satisfaction is high. Obtaining real-time feedback can occur via automated user queries or prompts provided at relevant times.

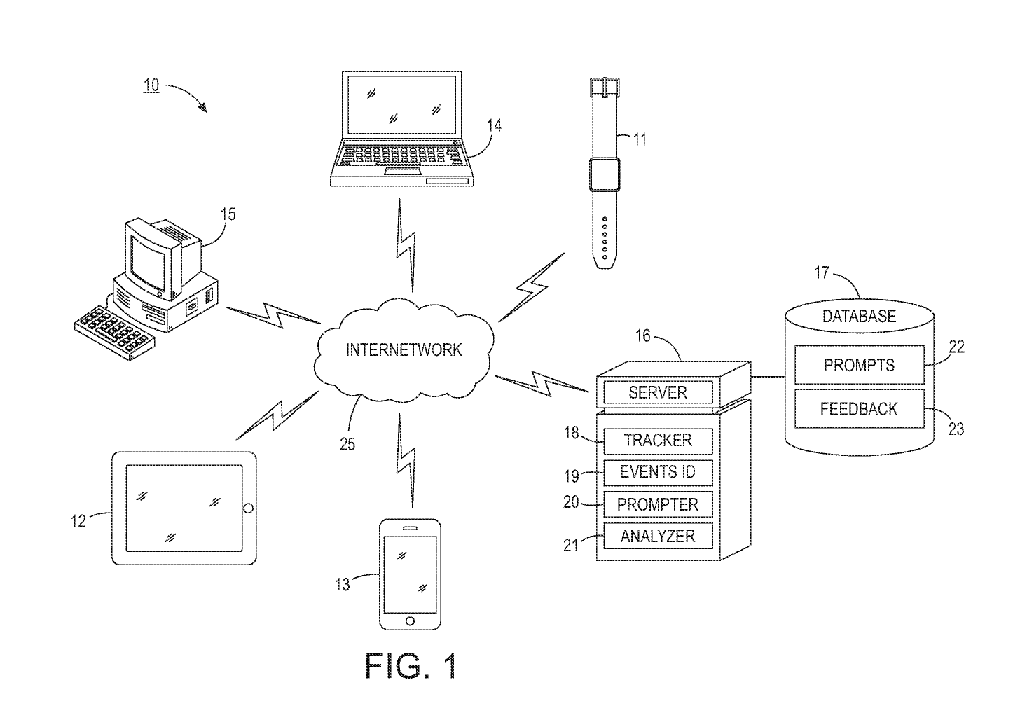

User prompts can be triggered by automatically inferring that an event took place that might be appropriate to solicit feedback and pushing one or more relevant questions without manual intervention based on the event. FIG. 1 is a block diagram showing a computer-implemented system 10 for automatic patient querying, in accordance with one embodiment. A patient admitted to a hospital can be associated with a device, such as a smartwatch 11, cellular telephone 13, tablet 12, laptop 14, desktop computer 15, television (not shown), remote (not shown), call button (not shown), or other device that can receive feedback from a patient. Each of the watch, cellular telephone, tablet, and laptop can be interconnected to a server 16 via an internetwork 25, such as the Internet. The server 16 includes a tracker 18, an events identifier 19, a prompter 20, and an analyzer 21. The tracker 18 can collect information regarding the patient and hospital employees associated with the patient. The patient information collected can include location data, proximity data, buttons selected on one or more of the devices associated with the patient, and other types of information. Meanwhile, the employee data can include schedules and location data, as well as other types of information.

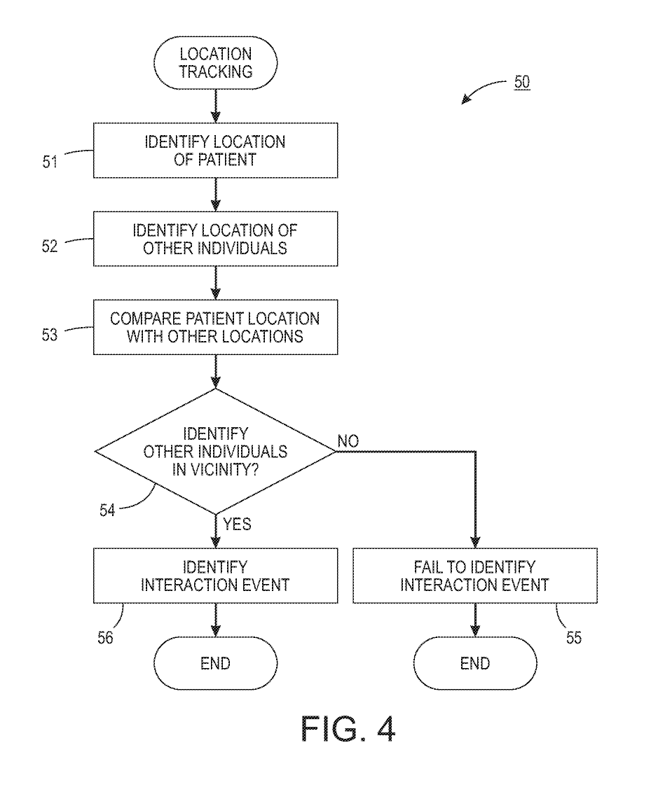

Subsequently, the events identifier 19 can process the information collected to determine an event, such as an interaction between the patient and one of the employees, about which patient feedback can be obtained. Determining events is further discussed below with reference to FIGS. 4-6. Each identified event can represent a trigger for prompting the patient for feedback. Thus, upon identification of an event, the prompter 20 can transmit a prompt 22 for feedback to one or more of the devices associated with the patient. The prompt 22 can include one or more questions, which are stored in a database 17 interconnected to the server 16. The questions selected for providing via the prompt can be based on the trigger event. Any feedback 23 received from the patient, in reply to the prompt, is then transmitted to the server 16, processed by the analyzer 21, and stored in the database 17.

The devices 11-14 and server 16 can each include one or more modules for carrying out the embodiments disclosed herein. The modules can be implemented as a computer program or procedure written as source code in a conventional programming language and is presented for execution by the central processing unit as object or byte code. Alternatively, the modules could also be implemented in hardware, either as integrated circuitry or burned into read-only memory components, and each of the client and server can act as a specialized computer. For instance, when the modules are implemented as hardware, that particular hardware is specialized to perform the data quality assessment and other computers cannot be used. Additionally, when the modules are stored into read-only memory components, the computer storing the read-only memory becomes specialized to perform the data quality assessment that other computers cannot. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

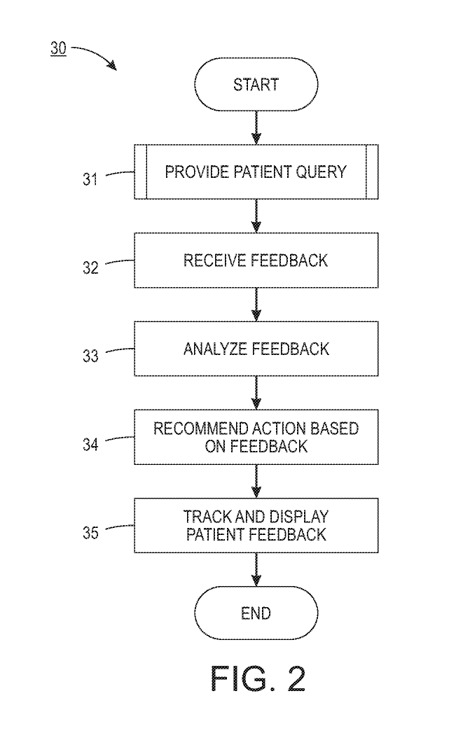

Automatic patient querying helps obtain feedback from a patient in real-time, which can then be analyzed to address any concerns of the patient, as described in detail in commonly-owned U.S. patent application Ser. No. 14/262,632, titled “Computer-Implemented System and Method for Real-Time Feedback Collection and Analysis,” filed on Apr. 25, 2014, the disclosure of which is hereby incorporated by reference. Specifically, analysis of the real-time feedback allows a business, such as a hospital, to remedy any customer or patient concern or dissatisfaction regarding an event during or close to the time of the event occurrence, rather than later. FIG. 2 is a flow diagram showing, by way of example, a process 30 for utilizing patient querying to increase patient satisfaction. Upon admittance to a hospital, a patient can be associated with at least one device that can collect information regarding the patient, as well as feedback data. The device can include a watch, cell phone, tablet, or a particular piece of hospital equipment, such as a bed with a receiver and transmitter, or a remote control that can receive feedback for analysis.

A prompt for soliciting feedback can be automatically provided (block 31) to the patient via one or more of the devices. The prompt can include one or more questions asking the patient to rate his/her experience and provide his/her satisfaction level regarding an event, such as an interaction or transaction. The questions can focus on the patient's condition or an entity associated with the patient, including a hospital employee or the hospital itself. The prompts can be helpful in obtaining truthful feedback from a patient who may otherwise be embarrassed or unwilling to provide the feedback to a person, such as a nurse. Specifically, in response to the prompts, the patient can provide feedback (block 32) via one of the devices. The device receiving the feedback can be the same or different than the device to which the prompt was sent. The feedback can include satisfaction scores based on numerical values, binary values, such as yes or no answers, short phases or sentences, or open-ended comments from the patient.

The feedback is then analyzed (block 33) to determine whether any action should be performed (block 34) to increase the patient's satisfaction levels, change hospital procedure, or award or discipline employees based on the feedback. In one embodiment, the patient feedback can be compared to a patient baseline, which is a measurement of initial feedback scores provided by the patient. The baseline can be determined as an average or median value of the initial feedback scores, or as a moving average as further described below. As an example, a baseline can be generated for a patient's pain level. The patient generally indicates pain level at a 3 or 4 and has a baseline of 3.5, with the highest pain indicated by a score of 10. However, if the patient provides feedback that his/her pain level is at a 6, action may be recommended since the patient's feedback indicates that his/her pain level is at a much higher level than typically reported by the patient in the past. The action can include intervention with respect to the patient's care, such as administration of stronger pain medication, as well as a review of the patient's pain management plan, as determined appropriate by the patient's care team. In contrast, an action is unlikely to be recommended for a patient that provides his/her pain level at a 6, when his/her baseline pain level is around a 5. Baselines can also be used for other patient conditions, such as satisfaction, depression, tiredness, or loneliness, as well as other situations that may impact patient satisfaction. Additionally, a baseline can be generated for groups of patients across different medical care facilities or different units of the same facility for further analysis across those groups.

Upon collection, the feedback of one or more patients can be tracked and displayed (block 35) for providing to individuals, such as hospital administrators and employees, with online analyses of the real-time feedback and useful abstractions to carry out institution-level or provider level benchmarking and to correlate responses to clinical outcomes. For instance, feedback from multiple patients can be used to determine whether an employee needs additional training or reprimanding based on the patients' satisfaction levels. An employee that consistently receives negative feedback relative to peers in the same or comparable position or level of responsibility could be reviewed to determine why the scores provided by the patients are consistently low. The comparison can occur among employees in the same or comparable positions to account for the different types of practices and patient conditions within those practices. Further, a comparison of scores from patients based on overall patient prognosis can be made. Alternatively, an employee that has a high baseline for patient satisfaction, but recently receives low scores, may be dealing with a personal problem that is affecting her job or may be unhappy with the job, and such a situation may need to be investigated in a timely fashion before patient care is impacted.

With respect to hospitals, branches, or departments within a hospital, the feedback can be used to determine whether the hospital needs to take action to improve medical services or hospital conditions. For example, a hospital that has a high rate of dissatisfaction and repeat patient admittance may need to review and revise treatment guidelines to increase patient satisfaction and decrease patient readmittance.

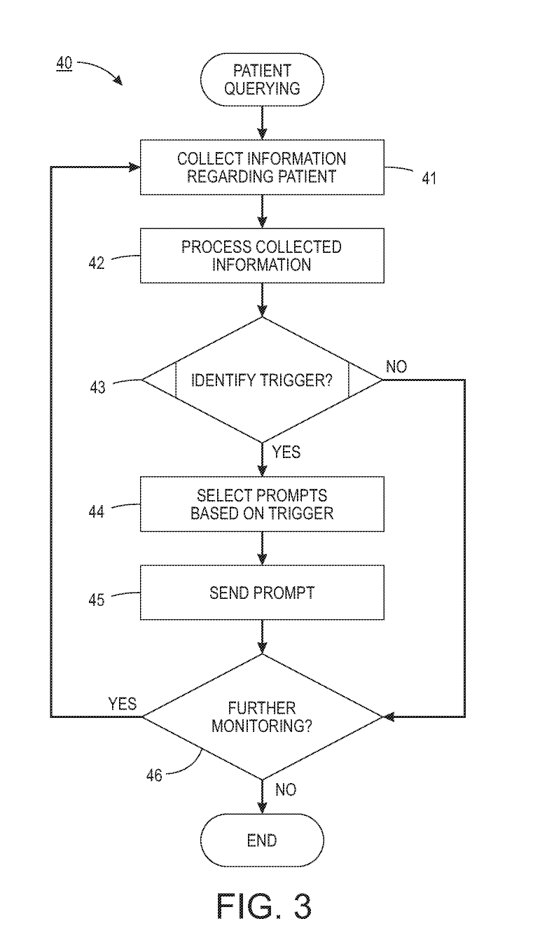

The automatic querying of patient feedback can be based on collected information regarding a patient and other individuals associated with that patient. FIG. 3 is a flow diagram showing a computer-implemented method 40 for automatic patient querying, in accordance with one embodiment. The patient can be monitored to collect (block 41) information, including location data, proximity data, interaction data, patient records, and device usage. Other types of information are possible. The collected information can then be processed (block 42) to identify an event, which can act as a trigger (block 43) for automatically providing a prompt for useful feedback. The event can include an interaction with a hospital employee, such as a doctor, nurse, or food worker, a request for assistance, or a medical procedure, as well as a request for assistance and other types of events.

If a trigger event is not detected, a determination is made as to whether further monitoring (block 46) of the patient is required and if so, further information is collected (block 41). However, if an event has occurred, the trigger is identified (block 43) and a prompt is automatically selected (block 44) and transmitted (block 45) to the patient based on the trigger. Identifying a trigger event is further described below with reference to FIGS. 4-6. The prompt can include one or more questions for providing to the patient in an attempt to receive feedback. The questions can be selected based on the identified trigger event. In one example, the patient was identified to be in pain and a nurse dispensed pain medication to the patient. The prompt questions are selected based on the event of providing pain medication to the patient and can include, for example, “please rate your current level of pain from one to ten, is the pain worse in your left or right leg, and do you believe you need additional pain medication?” Each of the questions can be pre-generated and selected based on a relevance of that question to the identified event and patient. Alternatively, a set of questions can be pre-generated and organized into scripts. One or more of the scripts can be selected for providing to the patient as a series of questions. In a further embodiment, more than one prompt can be provided based on an event. Returning to the above example, the identified event included a nurse providing the patient with pain medication and a prompt with one or more questions regarding the patient's pain is delivered. However, a further set of questions can be provided as another prompt at a later time period to ensure that the patient's pain level is reduced or the action was taken in a timely fashion.

Depending on the trigger event identified, the prompt can be delivered to a device associated with the patient immediately upon determination or after a predetermined amount of time has passed. For instance, if a meal is delivered to the patient, the prompt for feedback regarding the meal can be immediately provided upon determination. However, if the patient is recovering from an identified surgery, the prompt can be delivered after a predetermined amount of time to ensure that the patient is well enough to provide accurate and useful feedback.

The triggers include interaction events between a patient and another individual, which can be identified by tracking a location of the individuals within a hospital, as described in further detail in commonly-owned U.S. patent application Ser. No. 14/262,642, titled “Computer-Implemented System and Method for Tracking Entity Locations and Generating Histories from the Locations,” filed on Apr. 25, 2014, and in commonly-owned U.S. patent application Ser. No. 14/262,538, titled “Computer-Implemented System and Method for Tracking Objects Via Identifier-Tracker Pairings,” filed on Apr. 25, 2014, the disclosures of which are hereby incorporated by reference. The locations and location histories of the individuals, such as a patient and hospital employee, can be compared to determine whether two or more of the individuals are participating in an interaction. FIG. 4 is a flow diagram showing, by way of example, a process 50 for determining an interaction event based on location information. Each individual within a hospital can be associated with a tracker, such as an RFID tag or another tag emitting radio frequency (RF), sound, such as ultrasound, or light, such as infrared signals. The tag can be embedded in a patient identification bracelet or smartwatch, as well as an employee identification card used to clock in and out of the hospital and access restricted areas. A location of the patient is identified (block 51) by tracking the tag associated with the patient using tag readers positioned strategically throughout the hospital. The locations of other individuals in the hospital are also determined (block 52) by tracking the tags associated with those individuals. The location of the patient is compared (block 53) with the locations of the other individuals and a determination (block 54) is made as to whether any individual is within a predetermined vicinity of the patient's location.

If none of the other individual's locations are determined to fall within the predetermined vicinity, no interaction between the patient and the other individuals is identified (block 55). However, if the location of one or more of the other individuals is determined to be within the vicinity of the patient location, an interaction between the patient and that other individual is identified (block 56). In a further embodiment, an amount of time that the patient spends in the vicinity of another individual is tracked and a predetermined amount of time can be applied to the tracked time to prevent identification of a false interaction, such as when the patient is merely passing another individual. If the tracked time exceeds the predetermined amount of time, an interaction is identified. However, if the tracked time is less than the predetermined amount of time, no interaction is identified. The identified interaction event (block 56) can then be used as a trigger for transmitting a prompt soliciting feedback from the patient, as appropriate.

An interaction event can also be identified based on proximity tracking, rather than using specific locations. For example, the patient and each hospital employee can be associated with a wireless, such as Bluetooth enabled, beacon to determine whether the patient and one or more hospital employees are located within a reading range of one another. In one instance, a Bluetooth enabled device can be provided on a medication chart for the patient or located elsewhere in the patient's hospital room.

When the Bluetooth enabled devices or wireless beacons of the patient and an employee come within range of each other, communication between those devices occur and can be recognized as an interaction. In addition to patient-employee interactions, wireless beacons can also be used to determine a patient's proximity with respect to a particular object. For instance, wireless beacons can be located at an entrance of each room in the hospital and when the patient is within range of the entrance, communication between the beacon of that entrance and the patient's device is initiated to indicate the patient's presence in that room. In a further example, a dialysis machine can include a wireless beacon and the patient can be identified as interacting with the dialysis machine when in range. In a further embodiment, radio frequency, light, such as infrared light, or ultrasound can be used to track a proximity of the patient with respect to other individuals, including hospital employees, and objects or location.

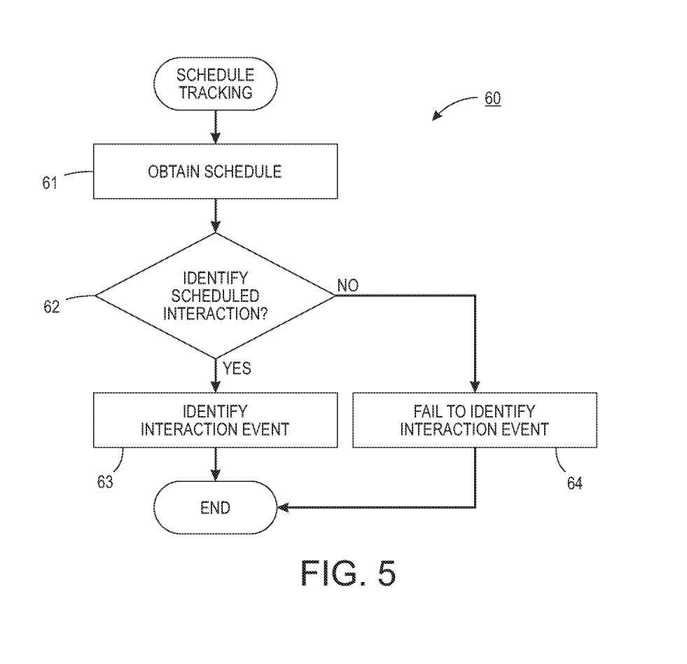

Interaction events between the patient and a hospital employee or other third party can also be determined based on a schedule of the employee or third party. FIG. 5 is a flow diagram showing, by way of example, a process 60 for determining an interaction event based on schedules. A schedule is obtained (block 61) for one or more hospital employees associated with the patient. For instance, schedules for the patient's doctor, nurse, and food service employee can be obtained at predetermined times, such as daily; periodically, such as twice a day to identify any schedule revisions; and randomly. Each schedule is reviewed to determine whether a scheduled interaction with the patient can be identified (block 62). For instance, if a schedule does not include a scheduled visit or meeting with the patient, an interaction event is not identified (block 64) and a prompt for feedback is not triggered. However, if a scheduled interaction with the patient is located on the schedule, an interaction event is identified (block 63). For instance, on a particular day, the doctor may be scheduled to visit the patient between 12 and 2 p.m., while a first nurse that works from 7 a.m. to 7 p.m. is scheduled to make four visits to the patient throughout the shift at 8:30 a.m., 11:30 p.m., 2:30 p.m., and 5:30 p.m. and a second nurse that works from 7 p.m. to 7 a.m. is scheduled to visit at 9:30 p.m., 11:30 p.m., and 6 a.m. Further, the food service employee is scheduled to deliver meals at 8 a.m., 12:30 p.m., and 6 p.m. Each scheduled interaction can represent a trigger for patient feedback and a prompt can be provided at a specified time after each scheduled interaction to determine, for example, whether the doctor or nurse addressed all the patient's concerns, if the patient has any remaining concerns, if the food was satisfactory, and if the patient is comfortable. Other types of prompts are possible.

In a further embodiment, a combination of scheduling and location can be used to ensure that an interaction event actually occurs. For example, to ensure an interaction occurred as scheduled, a location of the hospital employee scheduled to meet with the patient can be determined at a particular time or within a range of times to check whether the employee is within a particular vicinity or range of the patient to confirm occurrence of the interaction.

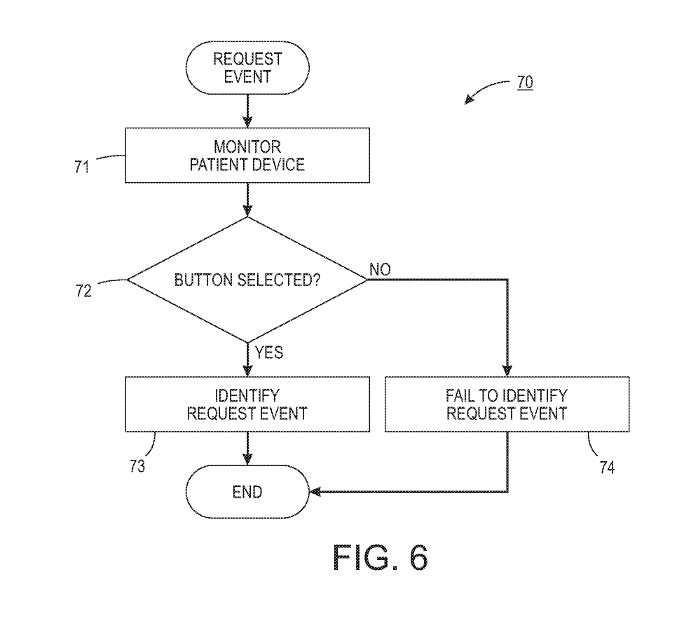

Another event appropriate for triggering a feedback prompt can include a request for assistance by the patient, which is likely followed by an interaction with the patient and an employee of the hospital. FIG. 6 is a flow diagram showing, by way of example, a process 70 for identifying a request for assistance based on a patient interaction with a device. The device associated with the patient is monitored (block 71). The device can include a smartwatch, cell phone, tablet, or a particular piece of hospital equipment, such as a bed with a receiver and transmitter, an emergency device, or a remote control that can identify a request for assistance by the patient, such as a call button. Next, a determination is made as to whether a request from the patient has been identified (block 72). The request can be identified via selection of a call button on a device, such as an emergency device provided by the hospital. Alternatively, the request can be identified via a text message or other message sent by the patient, or by a phone call from the patient. However, the request can be provided by the patient using other means.

If a request is not identified, an event for triggering a prompt is not identified (block 74). However, if a request is identified, an event is determined (block 73) as a trigger for providing a prompt for feedback to the patient. A request for assistance can indicate that an interaction between the patient and a hospital employee will occur to provide the assistance requested by the patient. Thus, the prompt can be provided a predetermined time after identifying the request event to determine, for instance, whether the request was fulfilled and if so, whether the patient was satisfied with the results.

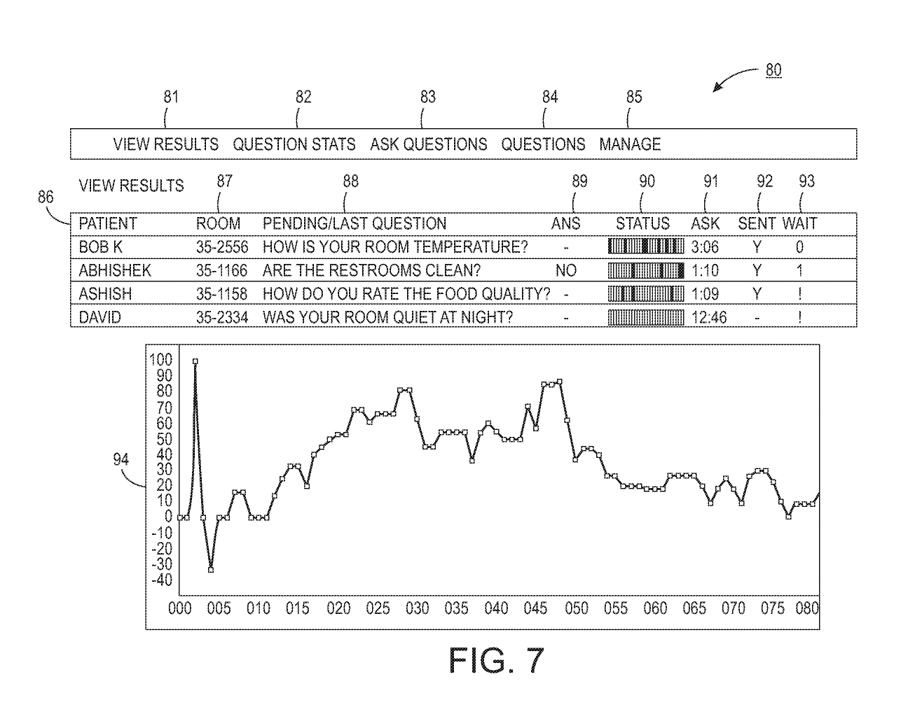

Once patient feedback has been collected, analysis and tracking can be performed to identify trends, problems, and patterns associated with the healthcare providers, patient care, and hospital based on average satisfaction levels of a group of patients. FIG. 7 is a screenshot showing, by way of example, a webpage 80 of compiled feedback data. The webpage 80 can be accessible by authorized users, such as employees and administrators, and can include tabs for “view results,” 81 “question stats,” 82 “ask questions,” 83 “questions,” 84 and “manage” 85. However, other tabs are possible. The view results tab 81 includes information about each patient within a group, such as on a common floor, managed by a common nurse, or having a common condition. Other types of groupings are possible. The groups can be selected and displayed by an authorized user. For instance, each individual can be associated with characteristic tags, such as for gender, age, residence, condition, and hospital room, as well as other characteristics. Subsequently, one or more of the characteristics can be selected for displaying a group of patients with those characteristics.

The information about each patient in the group can include an identity 86 of the patient, a location or room number 87 of the patient, a pending or last question 88 asked of the patient, an answer 89 to the last question asked, a status 90 of at least a portion of the questions provided to the patient, a time 91 that the pending or last question was asked, confirmation 92 that a notification of feedback was provided to a hospital employee or administrator, and a wait time 93 for feedback in reply to the last question.

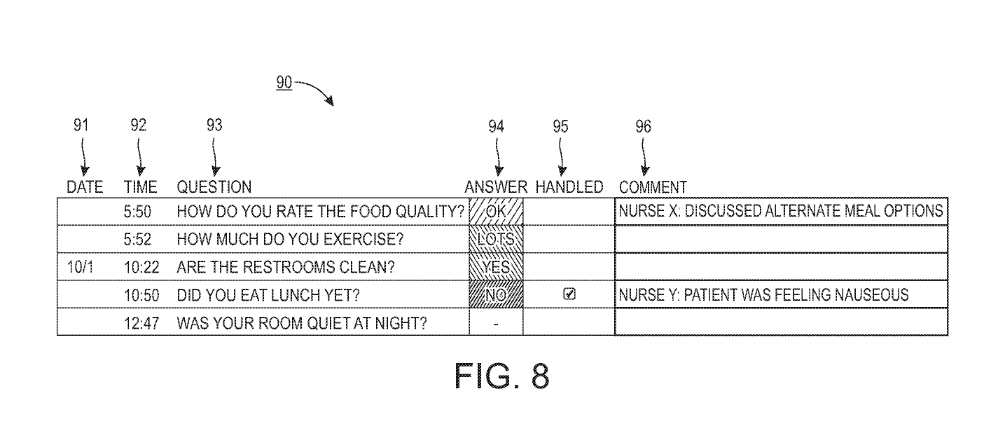

The patient list 86 can be selectable, such that when an employee or administrator clicks on a particular patient name, a new screen is provided with information about that patient, including a list of questions provided to the patient, feedback provided by that patient, whether the feedback has been addressed, an average time for the patient to provide the feedback, and an outcome of the patient provided feedback, including any actions performed by or notes entered by the employees. Other types of information are also possible, including the patient's medical record, contact information, and preferences. The selected patient screen is described below in further detail with respect to FIG. 8.

The status 90 can include a bar graph with one or more bars that each represent a question provided to the patient. Each bar can be color coded to represent a status of that question. For instance, a green color can represent that feedback from the patient has been adequately addressed, while a red color can indicate that feedback from the patient requires addressing and a grey color indicates that a question was sent, but no feedback has been received from the patient. Other colors are possible. Further, each bar can be selectable, such that when clicked on by an employee or administrator, a history of the question associate with the selected bar can be provided. For instance, the history can include the question itself along with any feedback provided, a reply to the feedback, and a screen for notes. The notes can include information, such as how the feedback from the patient was addressed. For example, a nurse that sees a patient unhappy with the noise level in his room can enter notes that she spoke with the patient, found the source of the noise, and was able to reduce the noise level. Once the patient's feedback has been adequately addressed, the color of the bar associated with the question for the feedback can be changed to green. Other colors and information for the question history are possible.

The notification 92 provides information whether a notification was sent to a hospital employee or administrator regarding receipt of feedback by the patient in reply to the last question. Providing notifications to employees and administrators can be helpful to ensure that any negative feedback is quickly reviewed and addressed. The notifications can be sent to specific employees based on the patient or the notifications can be sent to default contact and then distributed based on employee availability to address the feedback. In one embodiment, notifications are sent for all feedback received, but in a further embodiment, notifications are only sent for feedback that is determined to be negative, less than positive, or something that requires attention by the care team. For example, a notification should be sent to an employee for a patient that has received pain medication, but provides feedback that he is still in pain or has increased pain. Alternatively, a patient that indicates his pain has been relieved by the medication may require no further follow up.

The view results tab 81 can also include a graph 94 of the average satisfaction of the group of identified patients 86 over time. The graph 94 allows an employee or administrator to easily identify when patient satisfaction is decreasing. Timing of the periods of decreased patient satisfaction can be used to identify trends that may be causing the decreasing levels of satisfaction. For instance, a disliked nurse may be the cause of the decreasing satisfaction and can be identified based on decreasing levels that correlate with the shifts works by that nurse. Alternatively, patients in a certain department, such as obstetrics, may be more unsatisfied than patients in a different department, such as cardiology, and may indicate that the heath care professions in the obstetrics department may be undertrained or the facilities may be inadequate.

The graph 94 can include time along an x-axis and satisfaction values along a y-axis. In one embodiment, the satisfaction values can range from zero to 100 or from a negative value to 100, with 100 representing that all patients are satisfied. To obtain the average satisfaction values, each patient can be provided with ten questions in a prompt, which are each valued at 10 points. Based on the patient feedback, a score for the feedback can be analyzed and subsequently, averaged with the feedback scores from other patients. Other satisfaction value ranges and scoring methods are possible.

The question stats tab 82 can provide statistics for the questions provided to one or more groups of users, as well as statistics regarding feedback to the questions. The ask questions tab 83 can include questions received by one or more patients, while the questions tab 84 can include a list of all questions can that be provided as prompts to the patients. Finally, the manage tab 85 includes features for the authorized employees and administrators to analyze and edit the questions, or review the feedback and status data.

Upon selection of a patient on the complied feedback screen, a new screen is displayed with data particular to the selected patient. FIG. 8 is a screenshot showing, by way of example, a webpage 90 of a user profile for questions and feedback data. The data displayed for the selected patient can include a date 91 and time 92 at which the questions were provided to the patient, the questions provided to the patient, the feedback 94 received from the patient, whether any action to be performed in response to the feedback was handled 95, and comments 96. The comments can be entered by one or more members of the patient's care team. In one embodiment, one or more of the sections can be color coded to grab the attention of a care team member or other medical personnel. For example, the feedback column 94 can be color coded such that those answers from the patient that prompt an action to be performed can be colored red, while those answers that are positive can be colored green and those answers that are neutral are colored yellow. Other color schemes and categories for coding are possible.

Although the above has been described with respect to patients in a hospital, the automatic querying can also apply to customers of a business, employees of a company, and supporters of a non-profit organization. Other applications of the automatic querying are also possible.

While the invention has been particularly shown and described as referenced to the embodiments thereof, those skilled in the art will understand that the foregoing and other changes in form and detail may be made therein without departing from the spirit and scope of the invention.

What is claimed is:

1. A computer-implemented system for automatic patient querying, comprising:
a database to collect information regarding a user;
an event identification module to identify as a trigger an event associated with the user based on the collected information;
an inquiry module to identify one or more questions regarding the event;
a transmission module to automatically send the questions to the user as a prompt for information based on the trigger; and
a feedback module to receive feedback from the user in reply to the prompt.

2. A system according to claim 1, wherein the event comprises one of an interaction of the user with at least one of an individual, a piece of equipment, a location and food, device activity, and a request for assistance.

3. A system according to claim 1, further comprising:
a recommender to provide one or more recommendations to at least one of the user and a third party based on the feedback.

4. A system according to claim 1, further comprising:
a tracker to track the feedback received from each user; and
a notification module to notify a third party of the feedback.

5. A system according to claim 1, further comprising:
an event determination module to determine the event as an interaction between the user and an individual based on one or more of location data and proximity data, wherein the location data is obtained via one of RFID, ultrasound and infrared light and the proximity data is obtained via wireless beacons.

6. A system according to claim 1, further comprising at least one of:
a question tracker to track a status of each question provided to each user;
a display to display the tracked question status as a set of bars for each user, wherein each bar represents a question provided to that user;
an assignment module to assign a color to each bar based on a status of the feedback provided by the patient; and
a data module to provide information comprising at least one of the questions represented by that bar, feedback provided in response to the question, and whether the feedback has been addressed, upon selection of one of the bars by an authorized user.

7. A system according to claim 1, further comprising:
a satisfaction determination module to determine a level of satisfaction for the user and an average level of satisfaction based on the satisfaction level for the user and other users over a predetermined amount of time.

8. A system according to claim 7, wherein the satisfaction determination module determines at least one of an increase in satisfaction, satisfaction status quo, and an decrease in satisfaction.

9. A system according to claim 1, further comprising:
a comparison module to utilize the feedback from the user and other users by determining performances of at least two medical practitioners, departments, hospitals, and health systems based on the feedback and comparing the performances of the medical practitioners, departments, hospitals, or health systems.

10. A system according to claim 1, further comprising:
a trend identification module to collect the feedback from the user and other users over time for one or more of a medical provider, department, hospital, and health care system; and
a mapper to map the collected feedback to identify performance trends.

11. A computer-implemented method for automatic patient querying, comprising:
collecting information regarding a user;
identifying as a trigger an event associated with the user based on the collected information;
identifying one or more questions regarding the event;
automatically sending the questions to the user as a prompt for information based on the trigger; and
receiving feedback from the user in reply to the prompt.

12. A method according to claim 11, wherein the event comprises one of an interaction of the user with at least one of an individual, a piece of equipment, a location and food, device activity, and a request for assistance.

13. A method according to claim 11, further comprising:
providing one or more recommendations to at least one of the user and a third party based on the feedback.

14. A method according to claim 11, further comprising:
tracking the feedback received from each user; and
notifying a third party of the feedback.

15. A method according to claim 11, further comprising:
determining the event as an interaction between the user and an individual based on one or more of location data and proximity data, wherein the location data is obtained via one of RFID, ultrasound and infrared light and the proximity data is obtained via wireless beacons.

16. A method according to claim 11, further comprising at least one of:
tracking a status of each question provided to each user;
displaying the tracked question status as a set of bars for each user, wherein each bar represents a question provided to that user;
assigning a color to each bar based on a status of the feedback provided by the patient; and
upon selection of one of the bars by an authorized user, providing information comprising at least one of the question represented by that bar, feedback provided in response to the question, and whether the feedback has been addressed.

17. A method according to claim 11, further comprising:
determining a level of satisfaction for each user; and
determining an average level of satisfaction based on the satisfaction level for one or more of the users over a predetermined amount of time.

18. A method according to claim 17, further comprising:
determining at least one of an increase in satisfaction, satisfaction status quo, and an decrease in satisfaction.

19. A method according to claim 11, further comprising:
utilizing the feedback from the user and other users to compare performances of two or more medical practitioners, departments, hospitals, and health systems.

20. A method according to claim 11, further comprising:
collecting the feedback from the user and other users over time for one or more of a medical provider, department, hospital, and health care system; and
mapping the collected feedback to identify performance trends.
